(19) United States
(12) Patent Application Publication
(10) Pub. No.: US 2024/0231748 A1
(43) Pub. Date: Jul. 11, 2024

(54) DUAL AUDIO STREAM PROCESSING AND TRANSMISSION

(71) Applicant: Zoom Video Communications, Inc., San Jose, CA (US)

(72) Inventors: Qiang Gao, Charlotte, NC (US); Zhaofeng Jia, Saratoga, CA (US); Xiangming Zhu, Hefei (CN)

(21) Appl. No.: 18/095,663

(22) Filed: Jan. 11, 2023

(51) Int. Cl. G06F 3/16; H04L 65/403

(52) U.S. Cl. CPC G06F 3/165; H04L 65/403

(57) ABSTRACT

Systems and methods for dual audio stream processing and transmission are provided. For example, a method may include establishing, by a video conference provider, a virtual event having a plurality of participants. Each participant may exchange one or more audio or video streams via the virtual event using a plurality of client devices. The method may also include receiving, by the video conference provider, a first audio stream from a first client device and receiving, by the video conference provider, a second audio stream from the first client device. The first audio stream may be processed via a first audio process and the second audio stream may be processed via a second audio process to generate a first processed stream and a second processed stream, respectively. The method may include transmitting, by the video conference provider, the first processed stream and the second processed stream to a second client device.

### FIELD

The present application generally relates to video conferences, and more particularly relates to systems and methods for dual audio stream processing and transmission.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for dual audio stream processing and transmission, according to an embodiment herein;

FIG. 4 illustrates example audio profiles for processing and transmission of audio streams during a video conference, according to an embodiment herein;

FIG. 5 illustrates an example system for dual audio stream processing and transmission during a video conference, according to an embodiment herein;

FIG. 6 illustrates another example system for dual audio stream processing and transmission during a video conference, according to an embodiment herein;

FIG. 7 illustrates another example system for dual audio stream processing and transmission during a video conference, according to an embodiment herein;

FIG. 8 depicts another exemplary method for dual audio stream processing and transmission, according to an embodiment herein; and

FIG. 9 shows an example computing device suitable for dual audio stream processing and transmission, according to this disclosure.

### DETAILED DESCRIPTION

Examples are described herein in the context of systems and methods for dual audio stream processing and transmission. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As the popularity of virtual meetings to replace conventional, in-person meetings, continues to rise, so too does the prevalence of virtual events to replace traditionally in-person events. For example, virtual doctor's appointments are increasingly replacing in-person doctor's visits and virtual concert events are increasingly replacing in-person concerts. A draw of virtual events is the ability to connect individuals despite varying circumstances, such as illness, distance, or time zones.

Different types of virtual events, however, often have different multimedia needs. For example, a virtual meeting for a business call likely has different sound requirements than a virtual concert event. Even within a given virtual event, such as a virtual concert event, the multimedia requirements may differ depending on a time during the event or content being shared. That is, different audio streams generated by different inputs to a client device (e.g., a microphone, direct connection to an instrument, or a medical device), may have different audio requirements. For example, during a virtual concert event, an audio stream for the singer's microphone may have different audio requirements than an audio stream corresponding to a direct connect from the singer's guitar. Currently, multimedia streams transmitting during a given virtual event are processed and transmitting using a single audio profile. As such, the individual multimedia needs of different audio streams transmitted during the virtual event are not met and one or more of the audio streams are processed incorrectly.

Moreover, various types of virtual events can have different network bandwidth and encoding requirements. For example, a live-stream concert event including high-fidelity streams may require a higher bandwidth and a different encoding and decoding process than a standard virtual meeting. In another example, a virtual health visit in which a health official uses an electric stethoscope to listen to a patient's heart, the audio stream may be a high-fidelity stream to allow for accurate assessment. In such cases, a higher bandwidth and different encoding/decoding processes may be required than a standard virtual meeting.

As noted above, it can be difficult to meet ideal audio requirements of a virtual event using current approaches for audio stream processing because only one audio stream is output per participant, even if multiple different audio sources are provided by the participant. Thus, if a participant's device receives a mix of audio signals, each requiring different processing, then inevitably one of the audio signals may not be processed appropriately because of the “one-size-fits-all” operation of the audio processing functionality. For example, during a live-stream concert event, the audio stream from a concert recording device may include a mix of vocal signals and instrument signals from the various microphones and instruments. As noted above, it may be desirable to process these different input singles differently to accommodate different expectations for the different feeds. For example, the concert recording device may be configured to not subject the instrument signals to a denoise process as such a process may over-suppress certain acoustical sounds. It may, however, be desirable to subject the vocal signals to the denoise process to enhance the speech and clarity of the singer's voice. Since the concert recording device is transmitting a single audio stream to the video conference provider, current systems and techniques can only allow for both signals to be processed via the same manner. As such, either the audio stream is subjected to a denoise process, thereby negatively impacting the instrumental signals, or the audio stream is not subjected to the denoise process, thereby negatively impacting the vocal signals.

To process individual audio streams during virtual event according to each stream's audio requirements, example methods and systems for dual audio stream processing and transmission are provided herein. Depending on the type of virtual event (e.g., virtual meeting, webinar, live-stream concert event, virtual health visit), the audio signals received as part of an audio stream may be processed differently based on the audio requirements. For example, during a virtual meeting, audio streams received by a device microphone may be processed via a denoised process to suppress background noise and processed to enhance speech comprehensibility. In another example, during a live-stream concert event, the audio streams received from the stage may be minimally processed as a denoise process may over-suppress certain acoustical sounds, causing distortion of the live-stream music. Accordingly, the amount and way an audio stream is processed may vary depending on the type of virtual event. By processing individual audio streams based on each stream's audio requirements, each audio stream can be correctly processed to optimize and enhance the sound quality and character during a virtual event. This, in turn, can improve a user's experience during the virtual event.

This illustrative example is given to introduce the reader to the general subject matter discussed herein and the disclosure is not limited to this example. The following sections describe various additional non-limiting examples and examples of systems and methods for dual audio stream processing and transmission during a video conference.

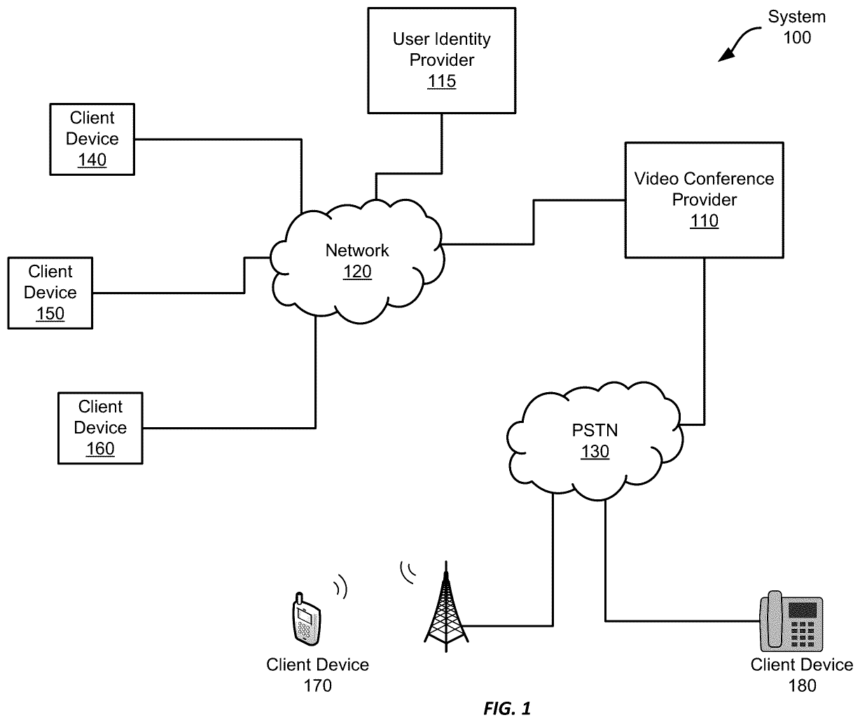

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more participant identity providers, e.g., participant identity provider 115, which can provide participant identity services to participants of the client devices 140-160 and may authenticate participant identities of one or more participants to the video conference provider 110. In this example, the participant identity provider 115 is operated by a different entity than the video conference provider 110, though in some examples, they may be the same entity.

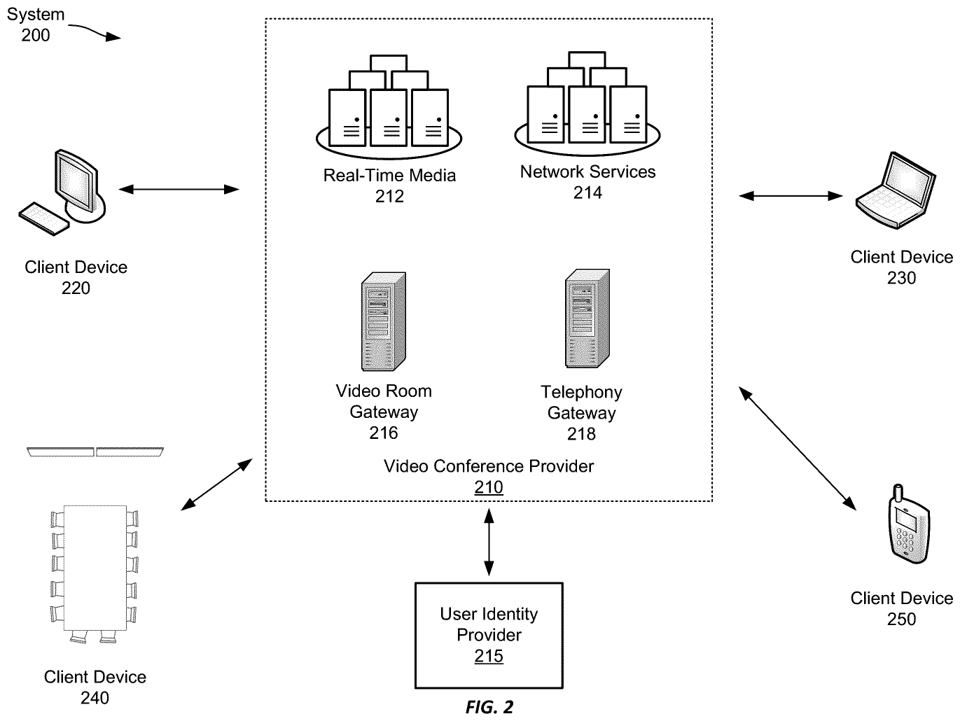

Video conference provider 110 allows clients to create video conference meetings or virtual events (or “meetings”) and invite others to participate in those meetings as well as perform other related functionality, such as recording the meetings, generating transcripts from meeting audio, generating summaries and translations from meeting audio, manage participant functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the video conference provider 110, a participant may contact the video conference provider 110 using a client device 540-180 and select an option to create a new meeting. Such an option may be provided in a webpage accessed by a client device 540-160 or client application executed by a client device 540-160. For telephony devices, the participant may be presented with an audio menu that they may navigate by pressing numeric buttons on their telephony device. To create the meeting, the video conference provider 110 may prompt the participant for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the participant may distribute the meeting information to one or more participants to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit participants to the meeting. Depending on the options set for the meeting, the participants may be admitted immediately upon providing the appropriate meeting identifier (and authentication information, as appropriate), even if the host has not yet arrived, or the participants may be presented with information indicating that meeting has not yet started or the host may be required to specifically admit one or more of the participants.

During the meeting, the participants may employ their client devices 140-180 to capture audio or video information and stream that information to the video conference provider 110. They also receive audio or video information from the video conference provider 210, which is displayed by the respective client device 540 to enable the various participants to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more participants to participate in a virtual event hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a participant to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the participant to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide participant identification information, meeting identifiers, meeting passwords or passcodes, etc. In examples that employ a participant identity provider 115, a client device, e.g., client devices 140-160, may operate in conjunction with a participant identity provider 115 to provide participant identification information or other participant information to the video conference provider 110.

A participant identity provider 115 may be any entity trusted by the video conference provider 110 that can help identify a participant to the video conference provider 110. For example, a trusted entity may be a server operated by a business or other organization with whom the participant has established their identity, such as an employer or trusted third-party. The participant may sign into the participant identity provider 115, such as by providing a username and password, to access their identity at the participant identity provider 115. The identity, in this sense, is information established and maintained at the participant identity provider 115 that can be used to identify a particular participant, irrespective of the client device they may be using. An example of an identity may be an email account established at the participant identity provider 110 by the participant and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a participant's “identity” relates to a secure, verified set of information that is tied to a particular participant and should be accessible only by that participant. By accessing the identity, the associated participant may then verify themselves to other computing devices or services, such as the video conference provider 110.

When the participant accesses the video conference provider 110 using a client device, the video conference provider 110 communicates with the participant identity provider 115 using information provided by the participant to verify the participant's identity. For example, the participant may provide a username or cryptographic signature associated with a participant identity provider 115. The participant identity provider 115 then either confirms the participant's identity or denies the request. Based on this response, the video conference provider 110 either provides or denies access to its services, respectively.

For telephony devices, e.g., client devices 170-180, the participant may place a telephone call to the video conference provider 110 to access video conference services. After the call is answered, the participant may provide information regarding a virtual event, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide participant identification information to identify the telephony device or the participant to the video conference provider 110. Thus, the video conference provider 110 may provide more limited functionality to such telephony devices. For example, the participant may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that participants may choose to participate in meetings anonymously and decline to provide participant identification information to the video conference provider 110, even in cases where the participant has an authenticated identity and employs a client device capable of identifying the participant to the video conference provider 110. The video conference provider 110 may determine whether to allow such anonymous participants to use services provided by the video conference provider 110. Anonymous participants, regardless of the reason for anonymity, may be restricted as discussed above with respect to participants employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 540-160 participating in the meeting. Encryption may also be provided during only a portion of a communication, for example, encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some participants from participating in a meeting.

By using the example system shown in FIG. 1, participants can create and participate in meetings using their respective client devices 140-180 via the video conference provider 110. Further, such a system enables participants to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more participant identity providers 215, which can authenticate various participants to the video conference provider 210 generally as described above with respect to FIG. 1.

In this example, the video conference provider 210 employs multiple different servers (or groups of servers) to provide different Examples of video conference functionality, thereby enabling the various client devices to create and participate in virtual events. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more virtual events to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency, and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 200. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a participant's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still, other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 200 and across many different real-time media servers 212.

Turning to the network services servers 214, these servers 214 provide administrative functionality to enable client devices to create or participate in meetings, send meeting invitations, create or manage participant accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a participant, e.g., a username and password or single sign-on credentials, to gain authenticated access to the video conference provider 210. This process may involve the network services servers 214 contacting a participant identity provider 215 to verify the provided credentials. Once the participant's credentials have been accepted, the network services servers 214 may perform administrative functionality, like updating participant account information, if the participant has an identity with the video conference provider 210, or scheduling a new meeting, by interacting with the network services servers 214.

In some examples, participants may access the video conference provider 210 anonymously. When communicating anonymously, a client device 220-250 may communicate with one or more network services servers 214 but only provide information to create or join a meeting, depending on what features the video conference provider allows for anonymous participants. For example, an anonymous participant may access the video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a participant wishes to schedule a meeting, the participant (anonymous or authenticated) may select an option to schedule a new meeting and may then select various meeting options, such as the date and time for the meeting, the duration for the meeting, a type of encryption to be used, one or more participants to invite, privacy controls (e.g., not allowing anonymous participants, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various participants.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent participants requesting access will be admitted to the meeting if the meeting record is located and the passcode matches the passcode supplied by the requesting client device 220-250. In some examples, additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another participant as the new meeting host and assign host administrative privileges to that participant. Hosts may have administrative privileges to allow them to manage their meetings, such as by enabling or disabling screen sharing, muting or removing participants from the meeting, assigning or moving participants to the mainstage or a breakout room if present, recording meetings, etc. Such functionality may be managed by the network services server(s) 214. For example, if a host wishes to remove a participant from a meeting, they may identify the participant and issue a command through a participant interface on their client device. The command may be sent to a network services server 214, which may then disconnect the identified participant from the corresponding real-time media server 212.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a participant later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information, etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosted by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a participant uses a telephony device to connect to a meeting, they may dial a phone number corresponding to one of the video conference provider's telephony gateway servers 218. The telephony gateway server 218 will answer the call and generate audio messages requesting information from the participant, such as a meeting ID and passcode. The participant may enter such information using buttons on the telephony device, e.g., by sending dual-tone multi-frequency (“DTMF”) audio signals to the telephony gateway server 218. The telephony gateway server 218 determines the numbers or letters entered by the participant and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the participant of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

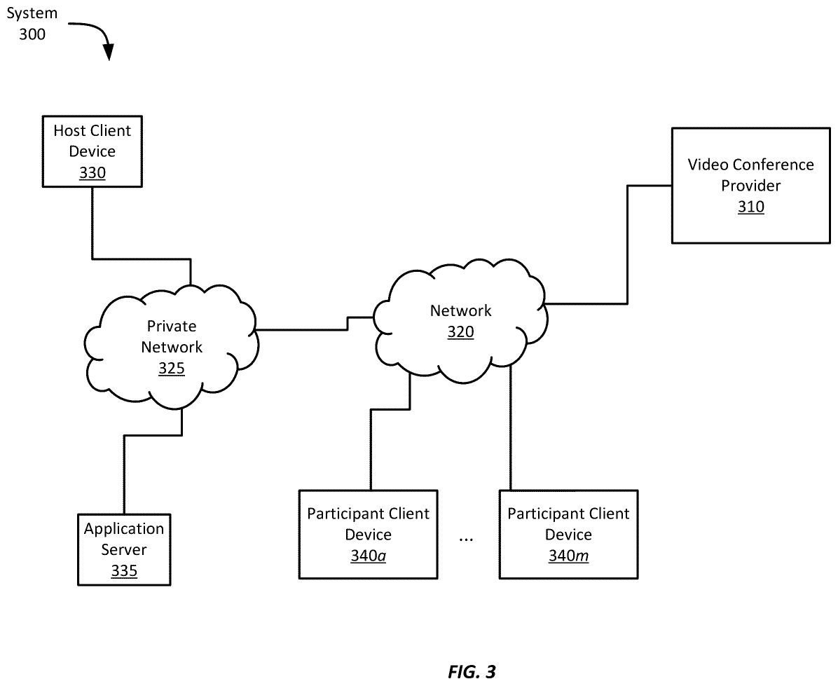

Referring now to FIG. 3, FIG. 3 shows an example system 300 for dual audio stream processing and transmission during a video conference. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a virtual event at the video conference provider 310, such as by beginning a scheduled meeting, generally as described above with respect to FIGS. 1 and 2. The video conference provider 310 may create and manage the meeting as discussed above.

Once the virtual event is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the webinar or certain select participants that will be engaged in discussions during the virtual event, such as panelists in a panel discussion. Still, other limits may be imposed on the various participants, such as their ability to react to occurrences during the meeting, e.g., participants may be allowed to interact with their GUI to raise their hand to ask a question but may not be allowed to provide any other feedback.

During the virtual event, the participants may be able to exchange audio and/or video streams. For example, the host client device 330 may transmit an audio stream to the participant client devices 340a-340m. In some embodiments, one or more of the participant client devices 340a-340m may be able to transmit an audio stream to the other meeting participants as well. For example, during a virtual meeting, all of the client devices 340a-340m and the client devices 330 may exchange audio streams. In another example, however, such as a live-streaming concert event, only the host client device 330 may be able to transmit an audio stream, while the client devices 340a-340m are prohibited from transmitting audio streams.

During the exchange of audio streams between meeting participants, the audio streams may be processed via a respective audio profile. The audio streams may be processed locally by a client device, such as the participant client device 340a, or the audio streams may be processed by the video conference provider 310. As noted above, conventionally, regardless of the number of audio signals generated by a client device, the audio streams transmitted by a single client device may be processed by a single audio profile. For example, if the host client device 330 included two microphones and thus generated two audio signals, all audio streams transmitted by the host client device 330 to the other meeting participants may be processed via a single audio profile. As can be appreciated, in some embodiments, the two audio signals generated by the host client device 330 may be transmitted as a single audio stream or may be transmitted as two separate audio streams to the video conference provider 310 for transmission to the other client devices 340a-340m. While the discussion herein involves two inputs to a single client device, and two audio signals and/or two audio streams from the single client device, it should be understood that any number of inputs may be received by a single client device, and any number of audio signals or audio streams may be generated and transmitted by the single client device.

An audio profile may determine how the audio stream is processed. For example, the audio profile may determine how the audio signals are processed, including any enhancement techniques that may be performed on the audio stream, such as a denoise process or speech enhancement process. In other words, processing the audio stream may change the audio properties of the audio stream to achieve a desired output, such as reducing background noise or enhancing the acoustics of the audio stream. Moreover, the audio profile may determine the bandwidth requirements for an audio stream. For example, the audio profile may determine whether transmission of the audio stream is a high-fidelity transmission or a low-fidelity transmission.

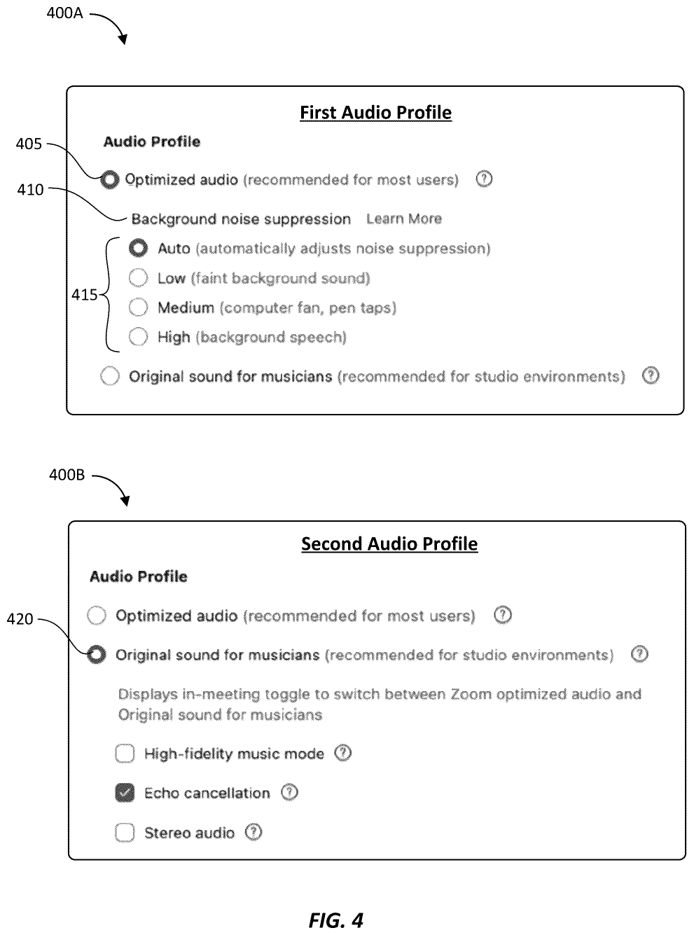

Referring now to FIG. 4, FIG. 4 illustrates example audio profiles 400A and 400B for processing and transmission of audio streams during a virtual event, according to an embodiment herein. As illustrated, a first audio profile 400A may include various settings for processing audio signals associated with an audio stream. For example, the first audio profile 400A may include an optimized audio selection 405. The optimized audio selection 405 may involve a speech enhancement process. For example, if the optimized audio selection 405 is selected, then the audio signals may be processed via a denoise process. A denoise process may process the audio signals to enhance speech quality and intelligibility within the audio signals. For example, the denoise process may remove or suppress background noise, as indicated by option 410. Upon selection of the optimized audio selection 405, options 415 may be provided to select the degree to which background noise suppression is performed on the audio signal. As can be appreciated, the speech enhancement process may be desirable during a virtual meeting or conference, where communication is mainly speech-based.

A second audio profile 400B may include various settings for processing audio signals associated with an audio stream. For example, the second audio profile 400B may include an option 420 for processing audio signals associated with non-speech content, such as music or instrument-based sounds. As can be appreciated, subjecting music or instrument-based sounds to a denoise process may over-suppress certain acoustical sounds, thereby causing distorting of the music. Thus, upon selection of the option 420, the audio signals may be subjected to an acoustical enhancement process. An acoustical enhancement process may process the audio signals such to allow for a full acoustical range. In some embodiments, the acoustical enhancement process may also process the audio signals to be transmitted via high-fidelity transmission. For example, the acoustical enhancement process may encode the audio signals for transmission as a high-fidelity stream. High-fidelity streams may require higher bandwidths and specific encoding/decoding techniques.

As noted above, an audio profile, such as the first and second audio profiles 400A and 400B, may determine settings or parameters for how an audio stream is processed. Parameters or settings may include a sampling rate, an output bitrate, application of pre-configured filters (e.g., speech enhancement, crowd noise control, acoustical enhancement, denoising process), application of custom filters (e.g., a digital equalizer may be provided to allow a user to manually adjust the equalization of an audio stream), mixing of the audio streams (e.g., options for a user to select the degree to which multiple audio streams are combined and/or processed), addition of sound effects to an audio stream (e.g., options may be provided to allow a user to add sound effects, such as cheering, to an audio stream), and the like. It should be appreciated that any other parameters used to process an audio stream may be included in the audio profile.

To help illustrate the issues that can result from using a single audio profile, an audio stream for a typical virtual meeting may be sampled at an average rate of 8-16 kHz which would adequately capture typical human speech. However, a high-fidelity audio stream, such as for a music performance, may be sampled at a much higher rate, such as 44.1 kHz or at even higher rates such as 96 kHz or 192 kHz, which results in a much higher bandwidth audio stream than for speech during a meeting. Sampling and processing a musical performance at 8-16 kHz would result in poor audio quality for the recording as many audio signals generated during the performance would not be accurately sampled. Further speech or singing may require different audio processing than audio signals generated by a musical instrument, as discussed above. Thus, different audio profiles may take these differences into account and may be appropriately applied to different input audio streams.

As noted above, conventionally, any audio signals generated by a client device and audio streams transmitted by the client device during a virtual event were processed using a single audio profile. Thus, regardless of the number of audio streams being transmitted by a client device, all of the audio streams are subjected to the same audio process. For example, during a virtual concert event, both a singer's vocals and the singer's guitar acoustics are processed using the same audio process, determined by the selected audio profile. Because both streams are subjected to the same audio process, at least one of the audio streams may not be appropriately processed.

To allow different audio streams from the same client device to be processed via an individual audio profile, example system and methods for dual audio stream processing and transmission are provided herein. The dual audio stream processing and transmission system may recognize that more than one audio signal is generated by a client device and allow a user to select an audio profile for each audio signal generated by the client device. For example, a user may select the first audio profile 400A for a first audio signal and the second audio profile 400B for a second audio signal. The first and audio signals may then be processed by the respective audio profile 400A and 400B.

In some embodiments, the first and second audio signals may be processed locally by the client device based on the determined audio profile 400A or 400B. In other embodiments, however, information of the respective audio profile 400A or 400B may be provided to a video conference provider, such as the video conference provider 310, and the video conference provider may process each of the first and second audio signals based on the respective audio profile 400A and 400B.

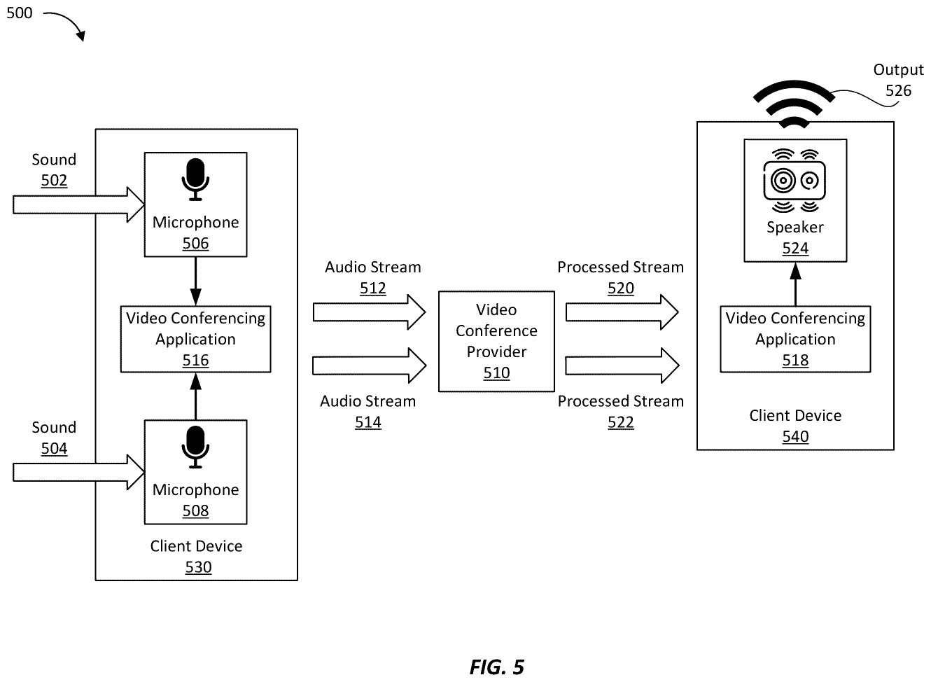

Turning now to FIGS. 5-7, various example scenarios in which multiple audio signals are generated by a single client device and processed via different audio profiles are provided. It should be appreciated that the following example scenarios are not meant to be limiting but instead are provided for ease of illustration and discussion.

Referring now to FIG. 5, FIG. 5 illustrates an example system 500 for dual audio stream processing and transmission during a virtual event, such as a live-streaming virtual event, according to an embodiment herein. The dual audio stream processing system 500 may include a client device 530, a client device 540, and a video conference provider 510. The client device 530 and the client device 540 may be joined to a virtual meeting hosted by the video conference provider 510. As such, one or more multimedia stream may be exchanged between the client device 530 and the client device 540. For example, as illustrated, the client device 530 may transmit a first audio stream 512 and a second audio stream 514 to the video conference provider 510 for transmission to the client device 540. Although not illustrated, the client device 540 may transmit one or more audio streams to the video conference provider 510 for transmission to the client device 530. One or more video streams may also be transmitted between the client devices 530 and 540 via the video conference provider 510.

As illustrated, the client device 530 may include a first microphone 506 and a second microphone 508. The first microphone 506 may capture an audio signal 502 and the second microphone 508 may capture an audio signal 504. The audio signal 502 and the audio signal 504 may require different audio processing. For example, the audio signal 502 may include vocal signals from a speaker while the audio signal 504 may include background sounds that are relevant to the speaker, such as cheering from a crowd. Because the audio signal 502 and the audio signal 504 require different audio processing, each of audio signal 502 and 504 may be assigned a different audio profile. An audio profile may identify one or more processing requirements of a given audio stream. For example, the audio signal 502 may require the first audio profile 400A such to include a denoise process and the audio signal 504 may require the second audio profile 400B such to include a high-fidelity process.

To process the audio signals 502 and 504, the audio signals 502 and 504 may be received by a video conferencing application 516 running on the client device 530 and transmitted to the video conference provider 510. In some embodiments, the audio signal 502 may be transmitted to the video conference provider 510 as the first audio stream 512 and the audio signal 504 may be transmitted to the video conference provider 510 as the second audio stream 514. The video conference provider 510 may process the first audio stream 512 via the first audio profile 400A and the second audio stream 514 via the second audio profile 400B. Upon processing the first audio stream 512 via the first audio profile 400A, a first processed stream 520 may be generated and upon processing the second audio stream via the second audio profile 400B, a second processed stream 522 may be generated.

In other embodiments, instead of sending the first audio stream 512 and the second audio stream 514 unprocessed to the video conference provider 510, the client device 530 may perform the processing of the audio streams. For example, the video conferencing application 516 may receive audio signals corresponding to the audio signal 502 from the first microphone 506 and process the audio signals to generate the first processed stream 520. Similarly, the video conferencing application 516 may receive audio signals corresponding to the audio signal 504 and process the audio signals to generate the second processed stream 522. The video conferencing application 516 may then transmit the first processed stream 520 and the second processed stream 522 to the video conference provider 510 as the first audio stream 512 and the second audio stream 514. It should be appreciated that it may be advantageous for the client device 530 to process the audio stream 512 and the audio stream 514 to generate the processed stream 520 and the process stream 522 for security and privacy reasons. For example, end-to-end encryption may be used during transmission of the processed streams 520 and 522 from the client device 530 to the client device 540. In such cases, the video conference provider 510 may not have the right to access the contents of the audio streams 512 and 514 or the processed streams 520 and 522. As such, the client device 530 may locally process the audio signals to generate the processed streams 520 and 522.

The video conference provider may transmit the first processed stream 520 and the second processed stream 522 to the client device 540. The first processed stream 520 and the second processed stream 522 may be received by a video conferencing application 518 running on the client device 540. The video conferencing application 518 may combine the first processed stream 520 and the second processed stream 522 to generate an output signal. The output signal may be sent to a speaker 524 of the client device 540 where the output signal is converted into an audio output 526. The audio output 526 may be in the form of acoustical signals or soundwaves.

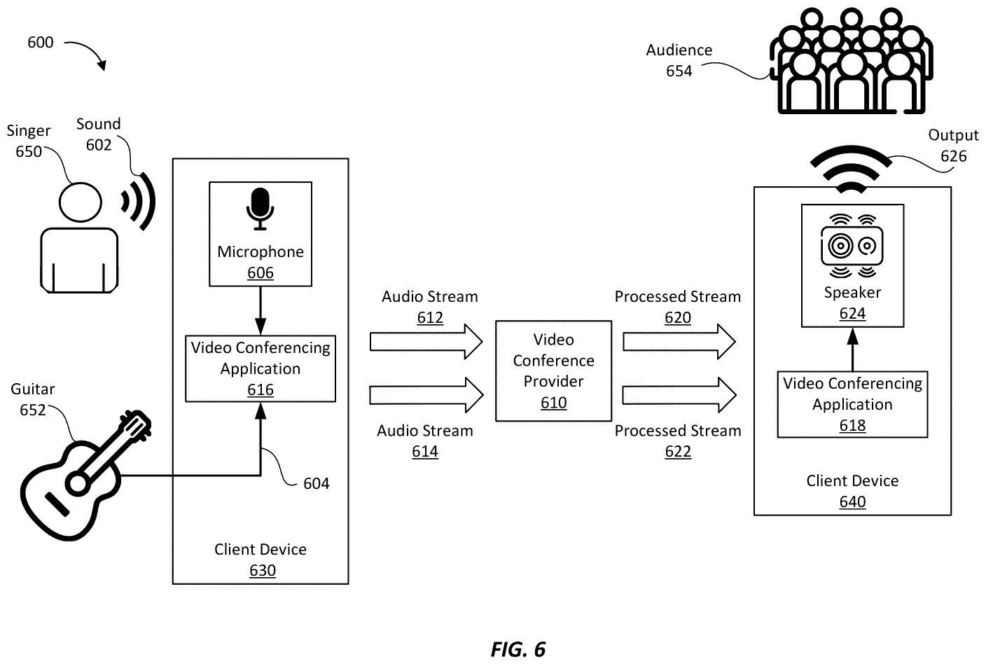

Referring now to FIG. 6, FIG. 6 illustrates another example system 600 for dual audio stream processing and transmission during a virtual event, according to an embodiment herein. The virtual event illustrated in FIG. 6 may be a virtual concert event involving a singer 650 and a guitar 625.

Similar to the example system 500, the system 600 may include a client device 630, a client device 640, and a video conference provider 610. The client device 630 and the client device 640 may be joined to the virtual concert event via the video conference provider 610. During the virtual concert event, one or more multimedia streams may be exchanged between the client device 630 and the client device 640. For example, as illustrated, the client device 630 may transmit a first audio stream 612 and a second audio stream 614 to the video conference provider 610 for transmission to the client device 640. Although not illustrated, the client device 640 may transmit one or more audio streams to the video conference provider 610 for transmission to the client device 630. One or more video streams may also be transmitted between the client devices 630 and 640 via the video conference provider 610. Moreover, while only one client device 640 is illustrated as receiving the first and second audio streams 612 and 614, it should be appreciated that there may be more than one client device 640.

As illustrated, the client device 630 may include a first microphone 606. The first microphone 606 may capture an audio signal 602. Instead of having a second microphone, the client device 630 may be directly connected to the guitar 652. For example, the guitar 652 may be an electric guitar that plugs directly into the client device 630. As such, the audio signal 604 from the guitar 652 may be received directly by the client device 630.

Because the audio signal 602 corresponds to vocals from the singer 650 and the audio signal 604 corresponds to an instrumental signal generated by the guitar 652, the audio signal 602 and the audio signal 604 may require different audio processing. For example, to enhance the vocals of the audio signal 602, the audio signal 602 may require a denoise process. In contrast, to not limit or interfere with the full range of acoustical sound generated by the guitar 652, the audio signal 604 may require an acoustical enhancement process. Moreover, the audio signal 604 may require high-fidelity processing to not lose any of the quality of the acoustical sound generated by the guitar 652.

Based on the different audio processing requirements, an audio profile may be determined for each of the audio signal 602 and the audio signal 604. For example, the audio signal 602 may require the first audio profile 400A such to include a denoise process and the audio signal 604 may require the second audio profile 400B such to include an acoustical enhancement process.

As discussed above with respect to FIG. 5, the audio signals 602 and 604 may be received by a video conferencing application 616 running on the client device 630 and transmitted to the video conference provider 610. The audio signal 602 may be transmitted to the video conference provider 610 as the first audio stream 612 and the audio signal 604 may be transmitted to the video conference provider 610 as the second audio stream 614. As noted above, in some embodiments, upon receipt of the first and second audio streams 612 and 614, the video conference provider 610 may process the first audio stream 612 via the first audio profile 400A and the second audio stream 614 via the second audio profile 400B. In other embodiments, the client device 630 may process the first and second audio streams 612 and 614 via the first audio profile 400A and the second audio profile 400B, respectively. Processing the first audio stream 612 via the first audio profile 400A may generate a first processed stream 620 and processing the second audio stream 614 via the second audio profile 400B may generate a second processed stream 622. When the first and second audio streams 612 and 614 are processed locally, the first processed stream 620 and the second processed stream 622 may be generated by the client device 630. In such cases, the first and second processed streams 620 and 622 may be transmitted to the video conference provider 610 in place of the first and second audio streams 612 and 614, as illustrated.

The video conference provider may transmit the first processed stream 620 and the second processed stream 622 to the client device 640. The first processed stream 620 and the second processed stream 622 may be received by a video conferencing application 618 running on the client device 640. In embodiments where one or more of the first and second processed streams 620 and 622 require decoding, the video conferencing application 618 may decode the processed audio stream as needed. In some embodiments, the video conferencing application 618 may combine the first processed stream 620 and the second processed stream 622 to generate an output signal. The output signal may be sent to a speaker 624 of the client device 640 where the output signal is converted into an audio output 626. In the illustrated example, the audio output 626 may be transmitted to an audience 654 of the virtual concert event.

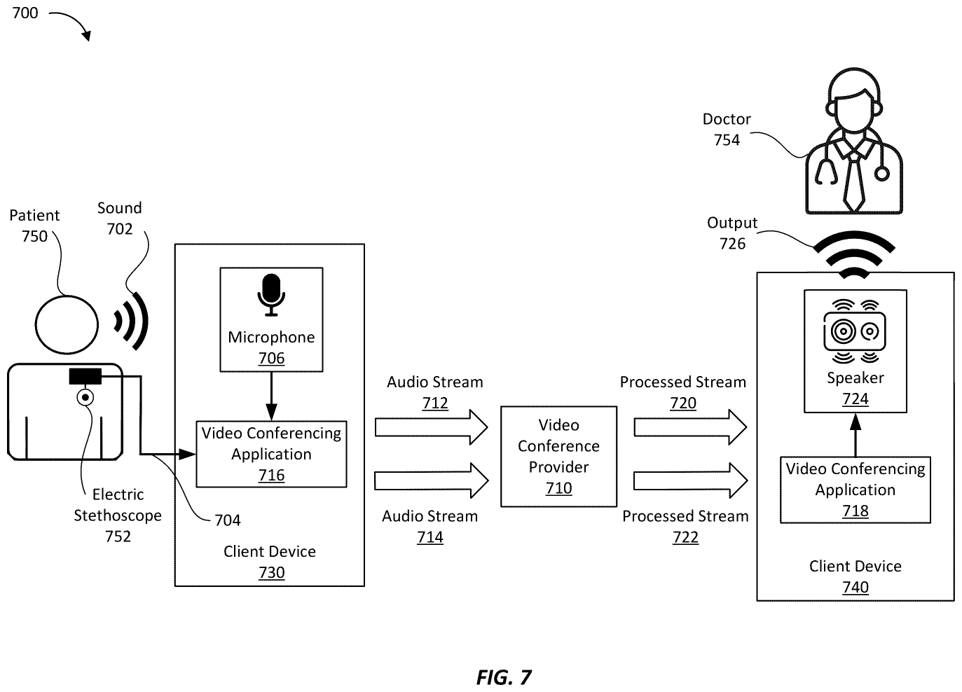

Referring now to FIG. 7, FIG. 7 illustrates yet another example system for dual audio stream processing and transmission during a virtual event, according to an embodiment herein. The virtual event illustrated in FIG. 7 may be a virtual doctor's visit involving a patient 750 and a doctor 754.

Similar to the example systems 500 and 600, the system 700 may include a client device 730, a client device 740, and a video conference provider 710. The client device 730 and the client device 740 may be joined to the virtual doctor's visit via the video conference provider 710. During the virtual doctor's visit, one or more multimedia stream may be exchanged between the client device 730 and the client device 740. For example, as illustrated, the client device 730 may transmit a first audio stream 712 and a second audio stream 714 to the video conference provider 710 for transmission to the client device 740. Although not illustrated, the client device 740 may transmit one or more audio streams to the video conference provider 710 for transmission to the client device 730. One or more video streams may also be transmitted between the client devices 730 and 740 via the video conference provider 710.

As illustrated, the client device 730 may include a microphone 706. The microphone 706 may capture an audio signal 702. During the virtual doctor's visit, the patient 750 may use an electric stethoscope 752 as part of the examination. To allow the doctor 754 to hear the patient's 750 heart in high enough quality for analysis, the electric stethoscope 752 may plug directly into the client device 730. Thus, the audio signal 704 generated by the electric stethoscope 752 may be directly received by the video conferencing application 716.

Because the audio signal 702 corresponds to speech from the patient 750 and the audio signal 704 corresponds to a signal generated by the electric stethoscope 752, the audio signal 702 and the audio signal 704 may require different audio processing. For example, to enhance the speech of the audio signal 702, the audio signal 702 may require a denoise process. In contrast, to not limit or interfere with the full range of acoustical sound generated by the electric stethoscope 752, the audio signal 704 may require an acoustical enhancement process. Moreover, the audio signal 704 may require high-fidelity processing to not lose any of the quality of the acoustical sound generated by the electric stethoscope 752. As can be appreciated, for examination purposes, having a high-quality audio stream from the audio signal 704 may be needed.

Based on the different audio processing requirements, an audio profile may be determined for each of the audio signal 702 and the audio signal 704. For example, the audio signal 702 may require the first audio profile 400A such to include a denoise process and the audio signal 704 may require the second audio profile 400B such to include an acoustical enhancement process.

The audio signals 702 and 704 may be received by a video conferencing application 716 running on the client device 730 and transmitted to the video conference provider 710. The audio signal 702 may be transmitted to the video conference provider 710 as the first audio stream 712 and the audio signal 704 may be transmitted to the video conference provider 710 as the second audio stream 714. In some embodiments, upon receipt of the first and second audio streams 712 and 714, the video conference provider 710 may process the first audio stream 712 via the first audio profile 400A and the second audio stream 714 via the second audio profile 400B. In other embodiments, the client device 730 may process the first and second audio streams 712 and 714 based on the first audio profile 400A and second audio profile 400B, respectively. Processing the first audio stream 712 via the first audio profile 400A may generate a first processed stream 720 and processing the second audio stream 714 via the second audio profile 400B may generate a second processed stream 722. As noted above, when the first and second audio streams 712 and 714 are processed locally, the first processed stream 720 and the second processed stream 722 may be generated by the client device 730. In such cases, the first and second processed streams 720 and 722 may be transmitted to the video conference provider 710 in place of the first and second audio streams 712 and 714, as illustrated.

The video conference provider 710 may transmit the first processed stream 720 and the second processed stream 722 to the client device 740. In some embodiments, the video conference provider 710 may combine the first and second processed streams 720 and 722 prior to transmitting the streams to the client device 740. The first processed stream 720 and the second processed stream 722 may be received by a video conferencing application 718 running on the client device 740. In embodiments where one or more of the first and second processed streams 720 and 722 require decoding, the video conferencing application 718 may decode the processed audio stream as needed. In some embodiments, the video conferencing application 718 may combine the first processed stream 720 and the second processed stream 722 to generate an output signal. The output signal may be sent to a speaker 624 of the client device 640 where the output signal is converted into an audio output 726. In the illustrated example, the audio output 726 may be transmitted to the doctor 754 of the virtual doctor's visit.

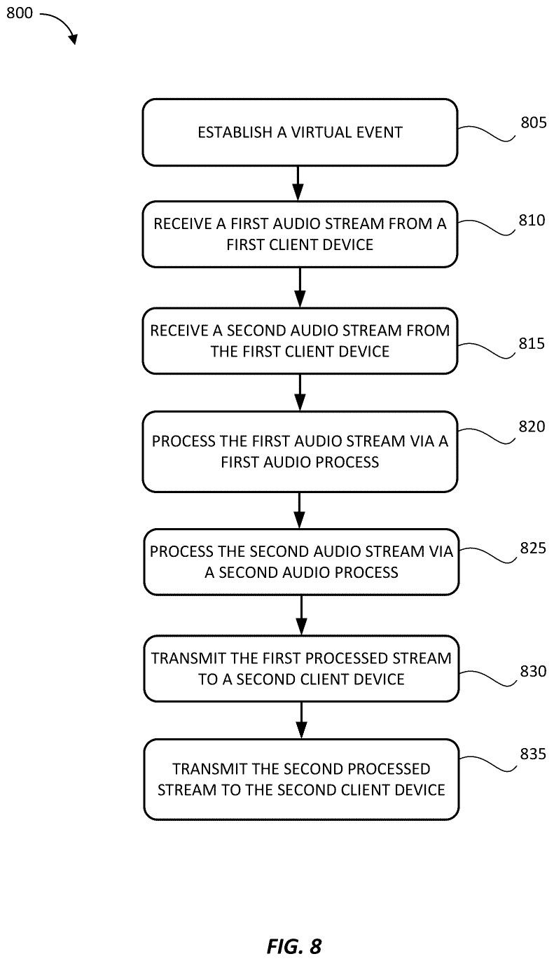

Referring now to FIG. 8, a flowchart of an example method 800 for dual audio stream processing and transmission is provided. For example, the method 800 may provide an example embodiment for initiating a collaborative session. The description of the method 800 in FIG. 8 will be made with reference to FIGS. 3-7, however any suitable system according to this disclosure may be used, such as the example systems 100 and 200, shown in FIGS. 1 and 2.

The method 800 may include steps 805 and 810. At step 805, the method 800 may include establishing, by a video conference provider, a virtual event having a plurality of participants. Each participant of the plurality of participants may exchange one or more audio or video streams via the virtual event using a plurality of client devices. For example, the video conference provider 310 may establish a virtual event for the participant client devices 340a-340m and the client devices 340a-340m may exchange audio streams during the virtual event. At step 810, the method 800 may include receiving, by the video conference provider, a first audio stream from a first client device of the plurality of client devices. For example, the video conference provider 310 may receive an audio stream from the client device 340a.

The method 800 may also include steps 815, 820, and 825. At step 815, the method 800 may include receiving, by the video conference provider, a second audio stream from the first client device. In some embodiments, steps 810 and 815 may be performed simultaneously. At step 820, the method 800 may include processing the first audio stream via a first audio process to generate a first processed stream. And similarly, at step 825, the method 800 may include processing the second audio stream via a second audio process to generate a second processed stream. The second audio process may be different from the first audio process. In an embodiment, the first audio stream may include a first type of audio signal and the second audio stream may include a second type of audio signal. For example, the first type of audio signal may include speech content and the second type of audio signal may include musical content. In such cases, the first audio stream may be processed via a denoise process to generate a denoised version of the first audio stream. Optionally, the second audio stream may be processed such to maintain original audio properties. For example, the second audio stream may include musical or acoustical content. In another example, the second audio stream may be processed via a high-fidelity quality process.

The method 800 may also include steps 830 and 835. At step 830, the method 800 may include transmitting, by the video conference provider, the first processed stream to a second client device of the plurality of client devices. At step 835, the method 800 may include transmitting, by the video conference provider, the second processed stream to the second client device. In some embodiments, the first processed stream and the second processed stream may be transmitted by the video conference provider to the second client device simultaneously. In another embodiment, the first processed stream may be transmitted to the second client device via a first channel and the second processed stream may be transmitted to the second client device via a second channel. The first channel may include a different bandwidth than the second channel.

In some embodiments, the method 800 may also include receiving, from the first client device, an indication of a first audio profile for processing the first audio stream via the first audio process and receiving, from the first client device, an indication of a second audio profile for processing the second audio stream via the second audio process. For example, the first audio stream may be processed based on the first audio profile 400A and the second audio stream may be processed based on the second audio profile 400B.

In some embodiments, the method 800 may also include identifying, by the video conference provider, a first audio-capturing device associated with the first audio stream, identifying, by the video conference provider, a second audio-capturing device associated with the second audio stream, and transmitting, by the video conference provider, a prompt to select a first audio profile associated with the first audio-capturing device and a second audio profile associated with the second audio-capturing device. In some embodiments, instead of providing a prompt to the first client device for selection of the first and second audio profiles, the video conference provider may determine an appropriate audio profile for each of the first and second audio streams. In such cases, the method 800 may include determining, by the video conference provider, a first audio profile for processing the first audio stream via the first audio process and determining, by the video conference provider, a second audio profile for processing the second audio stream via the second audio process. The first audio profile may be different than the second audio profile.

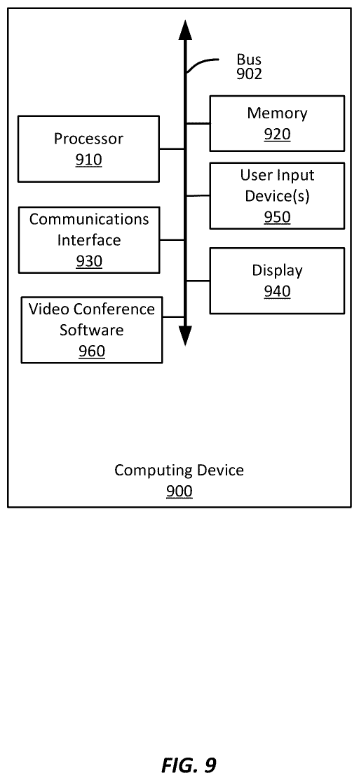

Referring now to FIG. 9, FIG. 9 shows an example computing device 900 suitable for use in example systems or methods for dual audio stream processing and transmission during a video conference. The example computing device 900 includes a processor 910 which is in communication with the memory 920 and other components of the computing device 900 using one or more communications buses 902. The processor 910 is configured to execute processor-executable instructions stored in the memory 920 to perform one or more methods for dual audio stream processing and transmission, such as part or all of the example method 800, described above with respect to FIG. 8. For example, the video conferencing software 960 provided on the computing device 900 may provide instructions for performing one or more steps of the method 800 for dual audio stream processing and transmission. The computing device, in this example, also includes one or more participant input devices 950, such as a keyboard, mouse, touchscreen, video input device (e.g., one or more cameras), microphone, etc., to accept participant input. The computing device 900 also includes a display 940 to provide visual output to a participant.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), Participant Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a method comprising: establishing, by a video conference provider, a virtual event having a plurality of participants, each participant of the plurality of participants exchanging one or more audio or video streams via the virtual event using a plurality of client devices; receiving, by the video conference provider, a first audio stream from a first client device of the plurality of client devices; receiving, by the video conference provider, a second audio stream from the first client device; processing the first audio stream via a first audio process to generate a first processed stream; processing the second audio stream via a second audio process to generate a second processed stream; transmitting, by the video conference provider, the first processed stream to a second client device of the plurality of client devices; and transmitting, by the video conference provider, the second processed stream to the second client device.

Example 2 is the method of any previous or subsequent Example, wherein the first processed stream and the second processed stream are transmitted by the video conference provider to the second client device simultaneously.

Example 3 is the method of any previous or subsequent Example, the method further comprising: receiving, from the first client device, an indication of a first audio profile for processing the first audio stream via the first audio process; and receiving, from the first client device, an indication of a second audio profile for processing the second audio stream via the second audio process.

Example 4 is the method of any previous or subsequent Example, wherein the first audio process is different than the second audio process.

Example 5 is the method of any previous or subsequent Example, wherein the first audio stream comprises a first type of audio signal and the second audio stream comprises a second type of audio signal.

Example 6 is the method of any previous or subsequent Example, wherein the first type of audio signal comprises speech content and the second type of audio signals comprise musical content.

Example 7 is the method of any previous or subsequent Example, wherein processing, by the video conference provider, the first audio stream via the first audio process to generate the first processed stream comprises: processing, by the video conference provider, the first audio stream via a denoise process to generate the first processed stream, wherein the first processed stream comprises a denoised version of the first audio stream.

Example 8 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: establish, by a video conference provider, a virtual event having a plurality of participants, each participant of the plurality of participants exchanging one or more audio or video streams via the virtual event using a plurality of client devices; receive, by the video conference provider, a first audio stream from a first client device of the plurality of client devices; receive, by the video conference provider, a second audio stream from a first client device of the plurality of client devices; process, by the video conference provider, the first audio stream via a first audio process to generate a first processed stream; process, by the video conference provider, the second audio stream via a second audio process to generate a second processed stream; transmit, by the video conference provider, the first processed stream to a second client device of the plurality of client devices; and transmit, by the video conference provider, the second processed stream to the second client device.

Example 9 is the system of any previous or subsequent Example, wherein the first audio stream and the second audio stream are received simultaneously by the video conference provider.

Example 10 is the system of any previous or subsequent Example, wherein the first audio process is different than the second audio process.

Example 11 is the system of any previous or subsequent Example, wherein: the processor-executable instructions to process, by the video conference provider, the first audio stream via the first audio process to generate the first processed stream further cause the processor to execute processor-executable instructions stored in the non-transitory computer-readable medium to process the first audio stream via a denoise process; and the processor-executable instructions to process, by the video conference provider, the second audio stream via the second audio process to generate the second processed stream further cause the processor to execute processor-executable instructions stored in the non-transitory computer-readable medium to process the second audio stream to maintain original audio properties.

Example 12 is the system of any previous or subsequent Example, wherein: the processor-executable instructions to process, by the video conference provider, the first audio stream via the first audio process to generate the first processed stream cause the processor to execute further processor-executable instructions stored in the non-transitory computer-readable medium to process the first audio stream via a denoise process; and the processor-executable instructions to process, by the video conference provider, the second audio stream via the second audio process to generate the second processed stream cause the processor to execute further processor-executable instructions stored in the non-transitory computer-readable medium to process the second audio via a high-fidelity quality process.

Example 13 is the system of any previous or subsequent Example, wherein the processor is further configured to execute processor-executable instructions stored in the non-transitory computer-readable medium to: identify, by the video conference provider, a first audio-capturing device associated with the first audio stream; identify, by the video conference provider, a second audio-capturing device associated with the second audio stream; and transmit, by the video conference provider, a prompt to select a first audio profile associated with the first audio-capturing device and a second audio profile associated with the second audio-capturing device.

Example 14 is the system of any previous or subsequent Example, wherein the processor is further configured to execute processor-executable instructions stored in the non-transitory computer-readable medium to: receive, from the first client device, an indication of a first audio profile for processing the first audio stream via the first audio process; and receive, from the first client device, an indication of a second audio profile for processing the second audio stream via the second audio process.

Example 15 is a non-transitory computer-readable medium comprising processor-executable instructions configured to cause one or more processors to: establish, by a video conference provider, a virtual event having a plurality of participants, each participant of the plurality of participants exchanging one or more audio or video streams via the virtual event using a plurality of client devices; receive, by the video conference provider, a first audio stream from a first client device of the plurality of client devices; receive, by the video conference provider, a second audio stream from a first client device of the plurality of client devices; process, by the video conference provider, the first audio stream via a first audio process to generate a first processed stream; process, by the video conference provider, the second audio stream via a second audio process to generate a second processed stream; transmit, by the video conference provider, the first processed stream to a second client device of the plurality of client devices; and transmit, by the video conference provider, the second processed stream to the second client device.

Example 16 is the non-transitory computer-readable medium of any previous or subsequent Example, wherein the processor is further configured to execute processor-executable instructions stored in the non-transitory computer-readable medium to: identify, by the video conference provider, a first audio-capturing device associated with the first audio stream; identify, by the video conference provider, a second audio-capturing device associated with the second audio stream; and determine, by the video conference provider, a first audio profile for processing the first audio stream via the first audio process; and determine, by the video conference provider, a second audio profile for processing the second audio stream via the second audio process.

Example 17 is the non-transitory computer-readable medium of any previous or subsequent Example, wherein: the instructions to determine, by the video conference provider, the first audio profile for processing the first audio stream via the first audio process cause the processor to execute further processor-executable instructions stored in the non-transitory computer-readable medium to receive, from the first client device, an indication of the first audio profile for processing the first audio stream via the first audio process; the instructions to determine, by the video conference provider, the second audio profile for processing the second audio stream via the second audio process cause the processor to execute further processor-executable instructions stored in the non-transitory computer-readable medium to receive, from the first client device, an indication of the second audio profile for processing the second audio stream via the second audio process; and the first audio profile is different than the second audio profile.

Example 18 is the non-transitory computer-readable medium of any previous or subsequent Example, wherein: the instructions to transmit, by the video conference provider, the first processed stream to the second client cause the processor to execute further processor-executable instructions stored in the non-transitory computer-readable medium to transmit, by the video conference provider, the first processed stream via a first channel to the second client device; the instructions to transmit, by the video conference provider, the second processed stream to the second client cause the processor to execute further processor-executable instructions stored in the non-transitory computer-readable medium to transmit, by the video conference provider, the second processed stream via a second channel to the second client device; and the first channel comprises a different bandwidth than the second channel.

Example 19 is the non-transitory computer-readable medium of any previous or subsequent Example, wherein the first processed stream and the second processed stream are transmitted by the video conference provider to the second client device simultaneously.

Example 20 is the non-transitory computer-readable medium of any previous or subsequent Example, wherein the first audio stream and the second audio stream are received from the first client device by the video conference provider simultaneously.

That which is claimed is:

1. A method comprising:
establishing, by a video conference provider, a virtual event having a plurality of participants, each participant of the plurality of participants exchanging one or more audio or video streams via the virtual event using a plurality of client devices;
receiving, by the video conference provider, a first audio stream from a first client device of the plurality of client devices;
receiving, by the video conference provider, a second audio stream from the first client device;
processing the first audio stream via a first audio process to generate a first processed stream;
processing the second audio stream via a second audio process to generate a second processed stream;
transmitting, by the video conference provider, the first processed stream to a second client device of the plurality of client devices; and
transmitting, by the video conference provider, the second processed stream to the second client device.

2. The method of claim 1, wherein the first processed stream and the second processed stream are transmitted by the video conference provider to the second client device simultaneously.

3. The method of claim 1, the method further comprising:
receiving, from the first client device, an indication of a first audio profile for processing the first audio stream via the first audio process; and
receiving, from the first client device, an indication of a second audio profile for processing the second audio stream via the second audio process.

4. The method of claim 1, wherein the first audio process is different than the second audio process.

5. The method of claim 1, wherein the first audio stream comprises a first type of audio signal and the second audio stream comprises a second type of audio signal.

6. The method of claim 5, wherein the first type of audio signal comprises speech content and the second type of audio signals comprise musical content.

7. The method of claim 5, wherein processing, by the video conference provider, the first audio stream via the first audio process to generate the first processed stream comprises:
processing, by the video conference provider, the first audio stream via a denoise process to generate the first processed stream, wherein the first processed stream comprises a denoised version of the first audio stream.

8. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
establish, by a video conference provider, a virtual event having a plurality of participants, each participant of the plurality of participants exchanging one or more audio or video streams via the virtual event using a plurality of client devices;
receive, by the video conference provider, a first audio stream from a first client device of the plurality of client devices;
receive, by the video conference provider, a second audio stream from a first client device of the plurality of client devices;
process, by the video conference provider, the first audio stream via a first audio process to generate a first processed stream;
process, by the video conference provider, the second audio stream via a second audio process to generate a second processed stream;
transmit, by the video conference provider, the first processed stream to a second client device of the plurality of client devices; and
transmit, by the video conference provider, the second processed stream to the second client device.

9. The system of claim 8, wherein the first audio stream and the second audio stream are received simultaneously by the video conference provider.

10. The system of claim 9, wherein the first audio process is different than the second audio process.

11. The system of claim 10, wherein:
the processor-executable instructions to process, by the video conference provider, the first audio stream via the first audio process to generate the first processed stream further cause the processor to execute processor-executable instructions stored in the non-transitory computer-readable medium to process the first audio stream via a denoise process; and
the processor-executable instructions to process, by the video conference provider, the second audio stream via the second audio process to generate the second processed stream further cause the processor to execute processor-executable instructions stored in the non-transitory computer-readable medium to process the second audio stream to maintain original audio properties.

12. The system of claim 10, wherein:
the processor-executable instructions to process, by the video conference provider, the first audio stream via the first audio process to generate the first processed stream cause the processor to execute further processor-executable instructions stored in the non-transitory computer-readable medium to process the first audio stream via a denoise process; and
the processor-executable instructions to process, by the video conference provider, the second audio stream via the second audio process to generate the second processed stream cause the processor to execute further processor-executable instructions stored in the non-transitory computer-readable medium to process the second audio via a high-fidelity quality process.

13. The system of claim 8, wherein the processor is further configured to execute processor-executable instructions stored in the non-transitory computer-readable medium to:
identify, by the video conference provider, a first audio-capturing device associated with the first audio stream;
identify, by the video conference provider, a second audio-capturing device associated with the second audio stream; and
transmit, by the video conference provider, a prompt to select a first audio profile associated with the first audio-capturing device and a second audio profile associated with the second audio-capturing device.

14. The system of claim 13, wherein the processor is further configured to execute processor-executable instructions stored in the non-transitory computer-readable medium to:
receive, from the first client device, an indication of a first audio profile for processing the first audio stream via the first audio process; and
receive, from the first client device, an indication of a second audio profile for processing the second audio stream via the second audio process.

15. A non-transitory computer-readable medium comprising processor-executable instructions configured to cause one or more processors to:
establish, by a video conference provider, a virtual event having a plurality of participants, each participant of the plurality of participants exchanging one or more audio or video streams via the virtual event using a plurality of client devices;
receive, by the video conference provider, a first audio stream from a first client device of the plurality of client devices;
receive, by the video conference provider, a second audio stream from a first client device of the plurality of client devices;
process, by the video conference provider, the first audio stream via a first audio process to generate a first processed stream;
process, by the video conference provider, the second audio stream via a second audio process to generate a second processed stream;
transmit, by the video conference provider, the first processed stream to a second client device of the plurality of client devices; and
transmit, by the video conference provider, the second processed stream to the second client device.

16. The non-transitory computer-readable medium of claim 15, wherein the processor is further configured to execute processor-executable instructions stored in the non-transitory computer-readable medium to:
identify, by the video conference provider, a first audio-capturing device associated with the first audio stream;
identify, by the video conference provider, a second audio-capturing device associated with the second audio stream; and
determine, by the video conference provider, a first audio profile for processing the first audio stream via the first audio process; and
determine, by the video conference provider, a second audio profile for processing the second audio stream via the second audio process.

17. The non-transitory computer-readable medium of claim 16, wherein:
the instructions to determine, by the video conference provider, the first audio profile for processing the first audio stream via the first audio process cause the processor to execute further processor-executable instructions stored in the non-transitory computer-readable medium to receive, from the first client device, an indication of the first audio profile for processing the first audio stream via the first audio process;
the instructions to determine, by the video conference provider, the second audio profile for processing the second audio stream via the second audio process cause the processor to execute further processor-executable instructions stored in the non-transitory computer-readable medium to receive, from the first client device, an indication of the second audio profile for processing the second audio stream via the second audio process; and
the first audio profile is different than the second audio profile.

18. The non-transitory computer-readable medium of claim 15, wherein:
the instructions to transmit, by the video conference provider, the first processed stream to the second client cause the processor to execute further processor-executable instructions stored in the non-transitory computer-readable medium to transmit, by the video conference provider, the first processed stream via a first channel to the second client device;
the instructions to transmit, by the video conference provider, the second processed stream to the second client cause the processor to execute further processor-executable instructions stored in the non-transitory computer-readable medium to transmit, by the video conference provider, the second processed stream via a second channel to the second client device; and
the first channel comprises a different bandwidth than the second channel.

19. The non-transitory computer-readable medium of claim 15, wherein the first processed stream and the second processed stream are transmitted by the video conference provider to the second client device simultaneously.

20. The non-transitory computer-readable medium of claim 19, wherein the first audio stream and the second audio stream are received from the first client device by the video conference provider simultaneously.
